(19) United States
(12) Patent Application Publication
(10) Pub. No.: US 2024/0351467 A1
(43) Pub. Date: Oct. 24, 2024

(54) Charging an Electric Vehicle at a Charging Column

(71) Applicants: Mariano HERRERO, Muenchen (DE); Eike RECKER, Muenchen (DE)

(72) Inventors: Mariano HERRERO, Muenchen (DE); Eike RECKER, Muenchen (DE)

(21) Appl. No.: 18/294,246

(22) PCT Filed: Aug. 1, 2022
(86) PCT No.: PCT/EP2022/071503

§ 371 Date: Feb. 1, 2024

(30) Foreign Application Priority Data
Aug. 2, 2021 (DE) 10 2021 119 965.4

(51) Int. Cl. B60L 53/67; B60L 53/31; B60L 53/66; B60L 53/68

(52) U.S. Cl. CPC B60L 53/67; B60L 53/31; B60L 53/66; B60L 53/68; B60L 2250/00

(57) ABSTRACT

A method for charging an electric vehicle at a charging column, wherein a charging process between the electric vehicle and the charging column is initiated, the charging behavior of the charging column is checked by the electric vehicle and if the charging behavior is found to be faulty, the electric vehicle terminates the current charging process, prevents other charging processes at this charging column, and outputs at least one message relative to the faulty charging behavior of the charging column.

### BACKGROUND AND SUMMARY

The invention relates to a method for charging an electric vehicle at a charging column, wherein a charging process between the electric vehicle and the charging column is initiated, the charging behavior of the charging column is checked by the electric vehicle and then, if faulty charging behavior is determined, the electric vehicle terminates the ongoing charging process. The invention also relates to an electric vehicle which is configured so as, once a charging process between the electric vehicle and the charging column has been initiated, to check the charging behavior of the charging column and then, if faulty charging behavior has been determined by the electric vehicle, to terminate the ongoing charging process. The invention further relates to a warning system having a data processing device which is able to be coupled to a plurality of electric vehicles of a vehicle fleet for the purpose of data transfer. Moreover, the invention relates to a system having a warning system and a plurality of electric vehicles, wherein the system is configured so as to allow the method to take place. In addition, the invention relates to a computer program product and a computer-readable storage medium comprising commands which, when the program is executed by a data processing device, cause this data processing device to perform the method.

Charging columns for electric vehicles may behave differently depending on their manufacturer. Some charging columns may even be manufactured in such a way that they do not adhere to international standards. Incompatibility in the implementation of the charging methods and/or protocols (“faulty charging behavior”) results in the charging of batteries of the electric vehicles being either considerably restricted or not possible, or may even permanently damage the charging infrastructure in the electric vehicle (e.g., comprising control units, the high-voltage battery, components, plugs, cables, etc.).

Currently, the electric vehicle interrupts the charging process immediately after faulty charging behavior has been identified. The customer, however, does not learn the reason for this termination. If the customer then wishes to retry the charging process, the charging process is restarted and then interrupted again. This retry scenario may result in the charging infrastructure in the electric vehicle becoming defective after a certain number of retries and needing to be replaced, probably in most cases at the cost of the vehicle manufacturer even though there is actually no warranty claim/quality problem on the part of the vehicle manufacturer. A disadvantageous consequence for the user is that their electric vehicle is not charged or is only insufficiently charged or even becomes defective.

On the website of the Tesla Motors Club, “How to report supercharger problems” describes the termination of a charging process which is communicated to a user in the form of a message on their smartphone via an application program (“app”). Upon termination of the charging, the user is given the recommendation to initiate a new charging process.

Furthermore, it is known that users can report defective charging columns to an operator of charging columns, e.g., by phone call or by reporting via a website.

It is the object of the present invention to at least partially overcome the disadvantages of the prior art and in particular to provide an improved possibility for protecting a charging infrastructure of an electric vehicle against the effects of faulty charging behavior caused by incompatible charging columns.

This object is achieved according to the features of the independent claims. Preferred embodiments can be gathered in particular from the dependent claims.

The object is achieved by a method for charging an electric vehicle at a charging column, wherein
a charging process between the electric vehicle and the charging column is initiated,
the charging behavior of the charging column is checked by the electric vehicle,
if faulty charging behavior is determined, the electric vehicle terminates the ongoing charging process, prevents further charging processes at this charging column and outputs at least one message relating to the faulty charging behavior of this charging column.

This method gives the advantage that the retry scenario which can potentially damage the vehicle charging infrastructure at a particular charging column can no longer occur. Additionally, a user can thus be informed about the cause of the charging termination and about the subsequent blocking of an initiation of new charging processes. In addition, the possibility is thus created to also inform users of other electric vehicles that have the same or similar vehicle charging infrastructure about the faulty charging behavior.

The electric vehicle can be a fully electrically driven vehicle or a hybrid vehicle. The electric vehicle can be a passenger car, truck, bus, motorcycle, etc.

The charging column can be a public or privately operated charging column. When an electric vehicle is connected to the charging column in order to charge its energy store (e.g., battery), the connection allows data to be exchanged between the electric vehicle and the charging column, e.g., information about the charging infrastructure of the electric vehicle can be transmitted to the charging column and a GPS position, a charging characteristic, the manufacturer, the model and/or a charging column ID of the charging column can be transmitted to the electric vehicle.

Upon the initiation of the charging process between the electric vehicle and the charging column, an attempt is made to carry out a charging process. If the electric vehicle prevents further charging processes at this charging column, this in particular encompasses that the electric vehicle does not attempt even once more to carry out a charging process. In one development, charging processes at this charging column can also be prevented in future, e.g., permanently, inside a predefined future period of time and/or until the charging column has been replaced, etc.

In one development, the output message comprises at least information which identifies the charging column such as a GPS position, a charging characteristic, the manufacturer, the model and/or a charging column ID of the charging column and/or an EVSE ID of the operator and in a further development can also comprise information relating to the electric vehicle outputting the message such as its VIN, information about the charging infrastructure installed in the electric vehicle, etc., and/or an error description.

It is one configuration that at least one message is output to a fleet operator of this electric vehicle and the fleet operator then reports at least the faulty charging behavior of this charging column or the faulty charging column to further electric vehicles of the vehicle fleet comprising this electric vehicle.

This achieves the advantage that other electric vehicles in front of this charging column can also be “warned” and react accordingly. In particular, this charging column can be included in a blacklist of incompatible and/or faulty charging columns. The reporting can comprise the fleet operator outputting a warning message, e.g., in the sense of a “push” message, to the electric vehicles in question. In one variant, this push message only comprises information about the charging column identified as incompatible and/or faulty; in another variant it comprises the complete, updated blacklist. Alternatively or in addition, the reporting can comprise the provision of information about the charging column(s) identified as incompatible and/or faulty, which provision of information is able to be called up at least by electric vehicles of the fleet, e.g., in the sense of “pull” information, e.g., in the present case as an updated blacklist.

It is one development that the fleet operator is a manufacturer of the electric vehicle. It is then possible to warn, e.g., all or selected electric vehicles of this manufacturer. For this purpose, messages received from electric vehicles can be processed by a backend of the manufacturer and corresponding warning messages can be output or provided.

It is one configuration that the fleet operator reports the charging column having the faulty charging behavior (e.g., actively outputs it as a “push” message and/or provides it as “pull” information to be called up) only to electric vehicles that have the same vehicle charging infrastructure as or functionally similar vehicle charging infrastructure to the electric vehicle outputting the original message. This gives the advantage that for electric vehicles which have a significantly different vehicle charging infrastructure and for which this charging column is possibly compatible, the charging possibility at this charging column is not denied. Electric vehicles that have the same or a functionally similar charging infrastructure are commonly also referred to as electric vehicles “of the same E generation”. It is one development that for electric vehicles that have the same or a functionally similar charging infrastructure a different blacklist is provided than for electric vehicles having different vehicle charging infrastructure.

It is one configuration that electric vehicles notified about the faulty charging behavior of this charging column or the faulty charging column prevent charging processes at this charging column, that is to say in particular actually prohibit a charging process from being initiated. As a result, damage to the vehicle charging infrastructure caused by incompatible charging columns is advantageously prevented in a particularly reliable manner for a whole group of electric vehicles, in particular for other electric vehicles of the same E generation.

It is one configuration that, if an electric vehicle has a charging column as a destination, is approaching a charging column (e.g., up to 5 m) and/or is connected to a charging column via a charging cable, it then calls up a list of charging columns having faulty charging behavior (e.g., the blacklist) from the fleet operator or opens a previously called-up list and checks whether the destination charging column is included in the list, and if so prevents charging processes at the destination charging column and/or informs the user of the electric vehicle about the destination charging column or the presence thereof in the list.

It is one configuration that, if an electric vehicle has a charging column as a destination, it then calls up a list of charging columns having faulty charging behavior from the fleet operator or opens a previously called-up list and then checks whether this destination charging column is included in the list, and if so automatically selects another charging column, which is not included in the list, as a new destination or offers it to the user for selection as a new destination. This is particularly advantageous for self-driving electric vehicles which may in particular be configured so as to automatically select another charging column, which is not in the list, as a new destination.

It is one configuration that at least one message relating to the faulty charging behavior of this charging column and a charging termination is output to a user of this electric vehicle. It is thus possible to potentially inform not only a fleet operator but also the user of the electric vehicle in question, which satisfies an information requirement of the user and increases user satisfaction. Moreover, the user thus saves time since he/she will then more than ever no longer attempt to retry the charging process at this charging column. The message can also comprise the information that the electric vehicle in question can no longer be charged at this charging column.

The user can be notified for example by output of text messages on the frontend of the electric vehicle and/or on a smartphone of the user, e.g., on an app or a web portal. Alternatively or additionally, the user can receive visual and/or audible signals in the electric vehicle, e.g., on a display and/or by colored lighting in the region of the charging socket, etc.

It is one configuration that the at least one message output by the electric vehicle relating to the faulty charging behavior of the charging column comprises, in addition to data which identify this charging column, images of the charging column and/or of the surroundings of the charging column, which images are captured by the electric vehicle. This achieves the advantage that other electric vehicles to which the charging column having the faulty charging behavior is reported can also have the images transmitted to them, which makes it easier for a nearby user to identify the charging column having the faulty charging behavior.

The object is also achieved by an electric vehicle, wherein the electric vehicle is configured so as, once a charging process between the electric vehicle and the charging column has been initiated, to check the charging behavior of the charging column and then, if faulty charging behavior has been determined by the electric vehicle, to terminate the ongoing charging process, to prevent further charging processes of this electric vehicle at this charging column and to output at least one message relating to the faulty charging behavior of this charging column. The electric vehicle can be designed analogous to the method and has the same advantages.

The object is also achieved by a warning system having a data processing device which is able to be coupled to a plurality of electric vehicles of a vehicle fleet for the purpose of data transfer, wherein the data processing device is configured so as
to receive from an electric vehicle a message relating to a faulty charging behavior of a charging column including information which identifies this charging column;
to identify vehicles of the vehicle fleet which have the same vehicle charging infrastructure as or a functionally similar vehicle charging infrastructure to the electric vehicle sending this message, and
to report to the thus identified electric vehicles that this charging column is exhibiting faulty charging behavior.

The warning system can be designed analogous to the method and to the electric vehicle and gives the same advantages.

Moreover, the object is achieved by a system which is configured so as to allow the above-described method to take place. For this purpose, the system can in particular have a warning system as described above and a plurality of electric vehicles of which at least one electric vehicle is an electric vehicle as described above.

In addition, the object is achieved by a computer program product comprising commands which, when the program is executed by a data processing device, cause this data processing device to perform the method as described above.

Furthermore, the object is achieved by a computer-readable storage medium comprising commands which, when executed by a data processing device, cause this data processing device to perform the method as described above.

The above-described properties, features and advantages of this invention and the manner and way in which they are achieved will become clearer and more understandable in connection with the following schematic description of an exemplary embodiment which will be explained in greater detail in connection with the drawings.

### BRIEF DESCRIPTION OF THE DRAWING

FIG. 1 shows a sketch of a system BE, EF1 to EFn according to one possible exemplary embodiment of the invention.

### DETAILED DESCRIPTION OF THE DRAWING

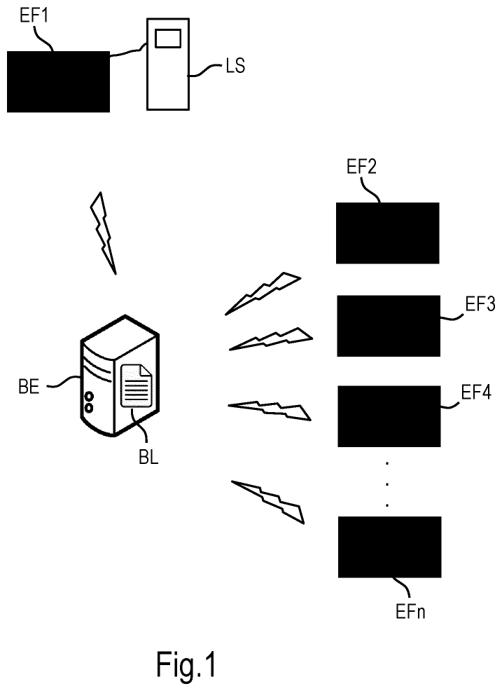

As illustrated in FIG. 1, the system BE, EF1 to EFn comprises a plurality of electric vehicles EF1, EF2, . . . , EFn of a vehicle fleet of a particular vehicle manufacturer and a warning system in the form of a backend BE of this vehicle manufacturer. At least some of the electric vehicles EF1, EF2, . . . , EFn belong to the same E generation. The backend BE and the electric vehicles EF1, EF2, . . . , EFn can exchange data with one another, e.g., via a radio communication network. In one development, data can be exchanged with the aid of mobile communication devices such as smartphones, etc., of the respective user.

At least some of the electric vehicles EF1, EF2, . . . , EFn are configured so as, once a charging process between the respective electric vehicle EF1, EF2, . . . , EFn and a charging column LS connected thereto has been initiated, to check the charging behavior of the charging column LS and then, if faulty charging behavior has been determined by the electric vehicle EF1, EF2, . . . , EFn, to terminate the ongoing charging process, to prevent further charging processes of this electric vehicle EF1, EF2, . . . , EFn at this charging column LS and to output at least one message relating to the faulty charging behavior of this charging column LS. This is described by way of example here for the electric vehicle EF1.

One possible message is a message which is output to a user of this electric vehicle and comprises information relating to the faulty charging behavior of this charging column and charging termination. This message can, e.g., be displayed on the electric vehicle EF1 and/or be output on a mobile communication device of the user. The charging termination can additionally be displayed, e.g., by visual and/or audible signals, for example by light signals at a charging socket of the electric vehicle EF1.

Another possible message is a message which is transmitted from the electric vehicle EF1 to the backend BE and comprises information relating to the faulty charging behavior of the charging column LS and data which uniquely identify the charging column such as its GPS position, ID, etc. In one variant, the message can additionally contain images of the charging column LS and/or of the surroundings of the charging column LS, which images are captured by the electric vehicle EF1.

The backend BE is configured so as to receive and further process the message transmitted from the electric vehicle EF1 relating to the faulty charging behavior of the charging column LS. The data processing here consists in the charging column LS being entered into a list BL containing faulty charging columns, which list BL is able to be called up by at least those electric vehicles EF1, EF2, . . . , EFn which belong to the same E generation as the electric vehicle EF1. Entering into the list BL can be interpreted to mean reporting that the charging column LS is exhibiting faulty charging behavior. Alternatively or additionally, a report that the charging column LS is exhibiting faulty charging behavior can be actively sent out (“push”) to the electric vehicles EF1, EF2, . . . , EFn, or the backend BE can output a message to the electric vehicles EF1, EF2, . . . , EFn that the list BL has been updated.

If one of the electric vehicles EF1, EF2, . . . , EFn has the charging column LS as a destination, is approaching the charging column LS and/or is connected to the charging column LS via a charging cable, it can call up the list BL of charging columns having faulty charging behavior or open a previously called-up list BL and then check whether the charging column LS is included in the list BL. If so, the electric vehicle EF1, EF2, . . . , EFn can prevent charging processes at this charging column LS and/or inform the user of the electric vehicle EF1, EF2, . . . , EFn about this charging column LS or the presence thereof in the list BL. Another charging column, which is not on the list BL, can also be chosen as a new destination.

The present invention is of course not limited to the exemplary embodiment shown.

Generally, “a”, “an”, etc., can be understood to mean a singular or a plural, in particular in the sense of “at least one” or “one or more”, etc., unless this is explicitly excluded, e.g. by the expression “precisely one”, etc.

Furthermore, numerical information can comprise precisely the specified number and also a customary tolerance range, unless this is explicitly excluded.

### LIST OF REFERENCE SIGNS

LS charging column
EF1-EFn electric vehicles
BE backend
BL list

1.-13. (canceled)

14. A method for charging an electric vehicle at a charging column, the method comprising:
initiating a charging process between the electric vehicle and the charging column;
checking the charging behavior of the charging column by the electric vehicle, and, in response to determining that a faulty charging behavior is present in the charging column, the electric vehicle terminates the charging process, prevents further charging processes at the charging column, and outputs a message relating to the faulty charging behavior of the charging column.

15. The method according to claim 14, wherein the message is output to a fleet operator of the electric vehicle and the fleet operator then reports at least the faulty charging behavior of the charging column to other electric vehicles of the vehicle fleet that includes the electric vehicle.

16. The method according to claim 15, wherein the fleet operator reports the charging column having the faulty charging behavior only to electric vehicles that have a vehicle charging infrastructure that is same as or functionally similar to a vehicle charging infrastructure of the electric vehicle outputting the message.

17. The method according to claim 15, wherein the other electric vehicles, which are notified about the faulty charging behavior of the charging column, prevent charging processes at the charging column.

18. The method according to claim 16, wherein the other electric vehicles, which are notified about the faulty charging behavior of the charging column, prevent charging processes at the charging column.

19. The method according to claim 15, wherein, for the electric vehicle that has the charging column as a destination, is approaching the charging column and/or is connected to the charging column via a charging cable, the electric vehicle then calls up a list of charging columns having faulty charging behavior from the fleet operator and checks whether the charging column is included in the list, and if included prevents charging processes at the charging column and/or informs a user of the electric vehicle about the charging column or a presence thereof in the list.

20. The method according to claim 16, wherein, for the electric vehicle that has the charging column as a destination, is approaching the charging column and/or is connected to the charging column via a charging cable, the electric vehicle then calls up a list of charging columns having faulty charging behavior from the fleet operator and checks whether the charging column is included in the list, and if included prevents charging processes at the charging column and/or informs a user of the electric vehicle about the charging column or a presence thereof in the list.

21. The method according to claim 17, wherein, for the electric vehicle that has the charging column as a destination, is approaching the charging column and/or is connected to the charging column via a charging cable, the electric vehicle then calls up a list of charging columns having faulty charging behavior from the fleet operator and checks whether the charging column is included in the list, and if included prevents charging processes at the charging column and/or informs a user of the electric vehicle about the charging column or a presence thereof in the list.

22. The method according to claim 15, wherein, for the electric vehicle that has the charging column as a destination, the electric vehicle then calls up a list of charging columns having faulty charging behavior from the fleet operator and then checks whether the charging column is included in the list, and if included selects another charging column, which is not included in the list, as a new destination or offers the another charging column for selection.

23. The method according to claim 16, wherein, for the electric vehicle that has the charging column as a destination, the electric vehicle then calls up a list of charging columns having faulty charging behavior from the fleet operator and then checks whether the charging column is included in the list, and if included selects another charging column, which is not included in the list, as a new destination or offers the another charging column for selection.

24. The method according to claim 17, wherein, for the electric vehicle that has the charging column as a destination, the electric vehicle then calls up a list of charging columns having faulty charging behavior from the fleet operator and then checks whether the charging column is included in the list, and if included selects another charging column, which is not included in the list, as a new destination or offers the another charging column for selection.

25. The method according to claim 14, wherein the message relating to the faulty charging behavior of the charging column and a charging termination are output to a user of the electric vehicle.

26. The method according to claim 15, wherein the message relating to the faulty charging behavior of the charging column and a charging termination are output to a user of the electric vehicle.

27. The method according to claim 14, wherein the message comprises data which identify the charging column and images of the charging column and/or of surroundings of the charging column, wherein the images are captured by the electric vehicle.

28. The method according to claim 15, wherein the message comprises data which identify the charging column and images of the charging column and/or of surroundings of the charging column, wherein the images are captured by the electric vehicle.

29. An electric vehicle configured, once a charging process between the electric vehicle and a charging column has been initiated, to:
check a charging behavior of the charging column, and
in response to determining that a faulty charging behavior is present in the charging column, terminate the charging process, prevent further charging processes of the electric vehicle at the charging column, and output a message relating to the faulty charging behavior of the charging column.

30. A warning system having a data processing device, which is able to be coupled to a plurality of electric vehicles of a vehicle fleet for data transfer, wherein the data processing device is configured so as to:
receive, from a first electric vehicle of the plurality of vehicles, a message relating to faulty charging behavior of a charging column including information which identifies the charging column;
identify electric vehicles of the vehicle fleet which have a vehicle charging infrastructure that is same as or functionally similar to a vehicle charging infrastructure of the first electric vehicle; and
report to the identified electric vehicles that the charging column is exhibiting faulty charging behavior.

31. A system comprising:
a plurality of electric vehicles of a vehicle fleet; and
a warning system having a data processing device, which is able to be coupled to the plurality of electric vehicles for data transfer, wherein the data processing device is configured so as to receive, from a first electric vehicle of the plurality of vehicles, a message relating to faulty charging behavior of a charging column including information which identifies the charging column, identify electric vehicles of the vehicle fleet which have a vehicle charging infrastructure that is same as or functionally similar to a vehicle charging infrastructure of the first electric vehicle, and report to the identified electric vehicles that the charging column is exhibiting faulty charging behavior;
wherein once a charging process between the first electric vehicle and the charging column has been initiated, the first electric vehicle is configured to check a charging behavior of the charging column, and in response to determining that the faulty charging behavior is present in the charging column, terminate the charging process, prevent further charging processes of the first electric vehicle at the charging column, and output the message relating to the faulty charging behavior of the charging column.

32. A computer program product comprising commands which, when the program is executed by a data processing device, cause the data processing device to perform a method according to claim 14.

33. A non-transitory computer-readable storage medium comprising commands which, when executed by a data processing device, cause the data processing device to perform a method according to claim 14.
